(19) United States
(12) Patent Application Publication
(10) Pub. No.: US 2008/0131044 A1
(43) Pub. Date: Jun. 5, 2008

(54) Antifriction Bearing for Supporting an Axle or Journal

(75) Inventors: Bernhard Bauer, Hassfurt (DE); Horst Gebauer, Sulzheim (DE)

Correspondence Address: BUCHANAN, INGERSOLL & ROONEY PC, POST OFFICE BOX 1404, ALEXANDRIA, VA, 22313-1404, US

(73) Assignee: AB SKF, Goteborg (SE)

(21) Appl. No.: 11/950,199

(22) Filed: Dec. 4, 2007

(30) Foreign Application Priority Data
Dec. 4, 2006 (DE) 10 2006 057 411.7

(51) Int. Cl. F16C 33/76; F16L 27/00

(52) U.S. Cl. 384/486; 403/60; 29/724

(57) ABSTRACT

An antifriction bearing for pivoting support of a journal includes a bush, roll bodies which roll in the bush, a gasket, and a disk spring which the roll bodies axially contact and which is axially supported on the gasket. The axial distance between the disk spring and the roll bodies decreases radially to the outside at least in areas.

### TECHNOLOGICAL FIELD

The invention generally relates to an antifriction bearing for pivoting support of an axle or journal. More specifically, the invention pertains to a bearing arrangement, a swivel joint with several bearing arrangements and a process for mounting an antifriction bearing on an axle or journal.

### BACKGROUND DISCUSSION

Antifriction bearings for support of an axle or journal are used especially in universal joints with which a torsionally strong, articulated connection between two machine parts, for example two shafts, can be formed. This universal joint generally has a journal cross with four journals which are each supported in one antifriction bearing. The antifriction bearings of two opposing journals at a time can be inlet into a fork-shaped end piece of one machine part each, the fork-shaped end pieces of the two machine parts being arranged so as to be turned by 90° against one another.

In this universal joint there is a gap, dictated by the design, between the antifriction bearing and the journal supported in it. To ensure permanent serviceability of the universal joint, it is necessary to reliably seal the gap. The sealing arrangement used in this connection should on the one hand prevent escape of the lubricant which is retained within the bearing and on the other should preclude penetration of impurities from the vicinity into the interior of the bearing bush or at least reduce it to an acceptable amount. This is important especially when the antifriction bearings are each provided with lifetime lubrication which must ensure adequate lubrication action over the entire intended service life.

Antifriction bearings with very high quality seal arrangements which meet very high demands with respect to reliable and permanent sealing are known. DE 10 2005 016 215 A1 discloses a bearing device with a bearing bush for pivoting support of a journal, and a seal arrangement for sealing the gap between the bearing bush and the journal. The seal arrangement has an inner and an outer gasket located axially next to one another in the region of the gap. A disk spring is axially supported on the inner gasket which is connected torsionally strong to the bearing bush. Roll bodies which are located in the bearing bush axially strike the disk spring. In this connection, the disk spring is arranged such that the axial distance between the disk spring and the roll bodies increases radially to the outside.

Also, DE 86 31 594.3 U discloses a bearing bush without play in which the gap between the bearing bush and the journal is sealed simply by a single gasket. The gasket is connected in a torsionally strong manner to the journal. Axially next to the gasket is a disk spring which the roll bodies located in the bearing bush strike axially and which is supported on the shoulder of the journal. The disk spring is arranged such that the axial distance between the disk spring and the roll bodies decreases radially to the outside.

It would be desirable to form an antifriction bearing for support of a journal such that reliable sealing of the gap between the antifriction bearing and the journal can be achieved with as little effort as possible.

### SUMMARY

The antifriction bearing for pivoting support of a journal as disclosed here comprises a bush, roll bodies which roll in the bush, a gasket, and a disk spring which the roll bodies contact or strike axially and which is axially supported on the gasket. The axial distance between the disk spring and the roll bodies decreases radially to the outside at least in areas.

With this construction of the antifriction bearing, it is possible to achieve a reliable sealing of the gap between the antifriction bearing and the journal, with the mechanical elements necessary for sealing requiring a comparatively small cost. The construction of the disk spring makes it possible on the one hand for the disk spring to be supported on the gasket, while on the other achieving a relatively high sealing action with a single gasket. The support of the disk spring on the gasket in the mounting of the antifriction bearing entails quite significant advantages relative to prior known constructions which require several successively connected gaskets for reliable sealing. This is due to the fact that a good sealing action can be achieved when one or more sealing lips of the gasket strike or contact the bush. However, due to the lack of mechanical stability, the region of the sealing lips is not very well suited to supporting the disk spring so that the known designs require an additional gasket or other measures for supporting the disk spring.

The gasket preferably has a sealing body and a support ring. In this way there is great freedom in the optimization of the interplay between the sealing properties and the mechanical stability of the gasket. In one preferred embodiment of the antifriction bearing, the disk spring adjoins the support ring with contact. This has the advantage that the sealing body will not be damaged by the mechanical action of the disk spring. Another advantage is that the support position of the disk spring and thus its pretensioning can be set with relatively small tolerances since the support ring yields much less than the sealing body.

The support ring preferably includes a first axially extending tube section. This imparts to the support ring relatively high mechanical stability in the axial direction in which the disk spring acts most strongly on the gasket. On the first tube section, a first flange which is pointed radially to the outside and/or a second flange pointed radially to the inside can be formed. The first flange can be located at least in one partial region of its radial extension outside on the sealing body, with the partial region preferably being larger than half the radial extension of the first flange. This has the advantage that the soft sealing body in this partial region is protected by the hard support ring. The disk spring preferably adjoins the second flange in a contacting manner. This yields a favorable contact surface for the disk spring. Preferably the support ring also includes a second axially extending tube section.

The desired properties of the support ring can be especially easily implemented when the support ring is made of metal.

In one preferred embodiment of the antifriction bearing, the disk spring possesses a bent radial region. The bent radial region extends preferably up to the maximum radius of the disk spring. In particular the roll bodies in the region of the bent radial region axially strike the disk spring. These mechanical measures allow good striking behavior between the roll bodies and the disk spring and thus keep wear low.

The gasket can be attached captively to the bush. In this way the manipulation of the antifriction bearing and its mounting are simplified.

Preferably, the gasket has a seating surface for a torsionally strong arrangement of the gasket on the journal. This has the advantage that reliable support of the disk spring on the gasket even with comparatively high pretensioning of the disk spring is possible, since support takes place in the vicinity of the seat.

Furthermore, it is advantageous if the gasket has at least one outer sealing lip which contacts the bush on the outside, and at least one inner sealing lip which contacts the bush on the inside. In this way a very high sealing action can be achieved. A further improvement of the sealing action and moreover facilitation of installation can be achieved by the gasket having an axial projection which axially adjoins the bush.

Another aspect of the disclosed subject matter relates to a bearing arrangement comprising a bush or sleeve, a journal pivotally supported in the bush, roll bodies which roll between the bush and the journal, a gasket, and a disk spring which is axially clamped with pretensioning between the gasket and the roll bodies. The axial distance between the disk spring and the roll bodies decreases radially to the outside at least in areas.

In one preferred embodiment of the bearing arrangement, the gasket is connected torsionally strong to the journal, forming a seal.

Another aspect of the disclosed subject matter pertains to a swivel joint which has several bearings in which one journal at a time is pivotally supported.

A further aspect relates to a process for installing an antifriction bearing on a journal, wherein the bearing includes a bush, roll bodies, a gasket and a disk spring. The process involves introducing the journal into the bush, and as the gasket approaches a defined seat position on the journal, the disk spring is increasingly compressed by the mechanical action of the gasket on the disk spring.

This process is advantageous in that relatively little manipulation effort is required for installing the antifriction bearing. In addition, defined pretensioning is preferably set by the compression of the disk spring. This has the advantage that the disk spring can be mounted relatively easily with a defined pretensioning.

### BRIEF DESCRIPTION OF THE DRAWING FIGURES

The subject matter disclosed herein is discussed below in more detail with reference to the accompanying drawing figures briefly described below in which like reference numerals designate like characters.

FIG. 1 is a cross-sectional view of a universal joint with one embodiment of the bearing device disclosed herein.

FIG. 2 shows an enlarged cross-sectional view of a portion of the universal joint shown in FIG. 1 in the region of the seal arrangement.

### DETAILED DESCRIPTION

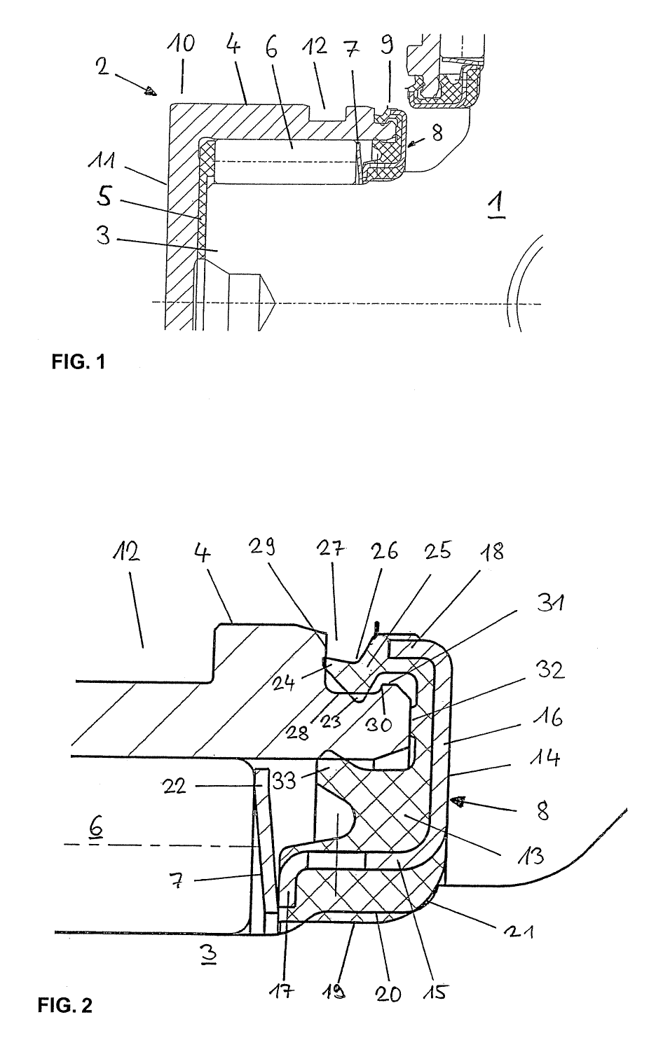

Referring to FIG. 1 showing a cross-section of a journal cross 1 with one embodiment of an antifriction bearing 2 disclosed herein, section. Only a part of the journal cross 1 is shown for purposes of simplicity, and it is to be understood that the journal cross 1 has four journals 3 which are each pivotally supported in a respective antifriction bearing 2. The description below relates to support of one of the journals 3 in one of the antifriction bearings 2. This means that the bearing unit described below is present four times per journal cross 1, one for each of the four journals.

The antifriction bearing 2 has a cylindrical bush 4, a stop disk 5, a set of cylindrical roll bodies 6 which roll in the bush 4, a disk spring 7 and a gasket 8. The bush 4 has an open axial end 9 at one end and a closed axial end 10 at the opposite end. The journal 3 is inserted into the open axial end 9 of the bush 4. A bottom 11 is formed in the region of the closed axial end 10 of the bush 4. The outer peripheral or jacket surface of the bush 4 includes a peripheral retaining groove 12 used for attachment purposes and into which a snap ring can be snapped for example.

The stop disk 5 is made of plastic, for example, and adjoins the bottom 11 of the bush 4. The roll bodies 6 and the journal 3 axially strike the stop disk 5. Furthermore the roll bodies 6 roll between the bush 4 and the journal 3 and are lubricated in doing so by a lubricant.

The disk spring 7 is axially clamped, with a pretensioning force, between the roll bodies 6 and the gasket 8 so that the roll bodies 6 axially contact or strike the disk spring 7. The gasket 8 is connected in a torsionally strong manner to the journal 3, forming a seal, and adjoins the bush 4 at several locations, forming a seal. Details associated with the structure and the arrangement of the gasket 8 are discussed below in more detail with reference to FIG. 2.

FIG. 2 shows, in an enlarged cross-section, a portion of the arrangement illustrated in FIG. 1 in the region of the gasket 8. The gasket 8 has a sealing body 13 and a support ring 14 located partially within the sealing body 13 and extending partially along the exterior surface of the sealing body 13.

In the illustrated embodiment, the support ring 14 is bent three times by 90° (inclusive of substantially 90°) each time so that the support ring 14 possesses three bend sections. The support ring 14 thus includes an inner tube section 15, an outer flange 16, an inner flange 17, and an outer tube section 18. The inner tube section 15 is oriented parallel to the axial direction of the antifriction bearing 2 (parallel to the journal 3). The outer flange 16 extends from one axial end of the inner tube section 15 (the axial end section of the inner tube section 15 farther from the rolling bodies 6). The outer flange 16 extends radially to the outside. The inner flange 17 is provided on the other axial end of the inner tube section 15 (the axial end section of the inner tube section 15 closer to the rolling bodies 6). The inner flange 17 of the support ring 14 extends radially to the inside (i.e., radially inward) and, in the illustrated embodiment, contacts the disk spring 7. As shown, the radial extension of the inner flange 17 is much smaller than the radial extension of the outer flange 16. The outer tube section 18 extends from the outer radial region of the outer flange 16 in the axial direction toward the same axial side of the outer flange 16 as the inner tube section 15.

The outer flange 16 of the support ring 14 is located outside the sealing body 13 on the exposed outer surface of the sealing body 13 in a partial region which is preferably larger than half the radial extension of the outer flange 16. In other words, in this embodiment, more than one-half of the radial extent of the outer flange 16 is located exteriorly of the sealing body. Also, in the illustrated embodiment, the outer flange 16 almost completely covers one axial side of the sealing body 13, namely the axial side of the sealing body 13 which faces away from the antifriction bearing 2. The outer tube section 18 of the support ring 14 extends near the maximum radial extension of the sealing body 13 within the sealing body 13. That is, the outer tube section 18 of the support ring 14 is positioned adjacent the radially outermost portion of the sealing body 13. The inner tube section 15 of the support ring 14 extends in the axial direction of the antifriction bearing 2 transversely through the entire sealing body 13 and is located nearer the journal 3 than to the bush 4. The radially inwardly extending inner flange 17 of the support ring 14 partially covers one axial side of the sealing body 13, namely the axial end side pointed toward or facing the antifriction bearing 2.

The sealing body 13 is preferably made of Viton or another elastomer material. The support ring 14 is preferably made of metal or a plastic of stable shape.

A seat surface 19 is formed in the region of the inner periphery on the sealing body 13. In the mounted state of the antifriction bearing 2, the seat surface 19 adjoins the opposing surface 20 of the journal 3. The radial overlap between the sealing body 13 and the journal 3 in the region of the seat surface 19 achieves a torsionally strong and sealed fixing of the gasket 8 on the journal 3. Reliable fixing in the axial direction is achieved by a shoulder 21 of the journal 3 which the support body 13 adjoins axially. In the opposite axial direction, the mobility of the gasket 8 is limited by the disk spring 7 which axially adjoins the inner flange 17 of the support ring 14.

The disk spring 7 increasingly approaches the roll bodies 6 radially to the outside, meaning that the disk spring 7 is positioned such that radially outer portions of the disk spring 7 are located closer to the roll bodies 6 than radially inner portions of the disk spring 7. In other words, the axial distance between the disk spring 7 and the roll bodies 6 decreases radially to the outside at least in areas. In the mounted state of the antifriction bearing 2, the disk spring 7 is oriented at an acute angle to the radial direction of the antifriction bearing 2. To achieve stopping behavior of the roll bodies 6 on the disk spring 7 in a most optimum manner possible, the disk spring 7 has a bent radial region 22 (a bent radially outermost region) which extends as far as the maximum radius of the disk spring 7. The bent radial region 22 is matched to the oblique position of the disk spring 7 in the mounted state of the antifriction bearing 2 such that it is aligned roughly parallel to the face surfaces of the roll bodies 6 which the disk spring 17 contacts.

The gasket 8 further includes a radially outer sealing lip 23 and an axial outer sealing lip 24 which are components or parts of an axial extension 25 of the sealing body 13 positioned in the region of the outer periphery of the gasket 8. The axial extension 25 extends from the outer tube section 18 of the support ring 14. The radially outer sealing lip 23 which is located nearer the open axial end 9 of the bush 4 and which is made mechanically more stable than the axial outer sealing lip 24 extends to the inside with respect to the radial direction. Preferably the radially outer sealing lip 23 however is not oriented exactly parallel to the radial direction, but rather encloses or forms an angle (i.e., an angle other than 0°) with the radial direction. The axial outer sealing lip 24 is located at the free end of the axial extension 25 of the sealing body 13 and is oriented obliquely to the outside with respect to the radial direction. Preferably the orientation is chosen such that it is nearer the axial direction than the radial direction. In the region in which the two outer sealing lips 23, 24 are provided, the sealing body 13 on its outer periphery has a peripheral depression 26 which in the illustrated embodiment has a V-shaped cross section.

The two outer sealing lips 23, 24 each adjoin the bush 4 in the region of a sealing groove 27 formed on the outer periphery of the bush 4. The sealing groove 27 in the illustrated embodiment has a rectangular cross section which is defined by a groove bottom 28, a first groove side wall 29 and a second groove side wall 30. The transition regions between the groove bottom 28 and the groove side walls 29, 30 of the sealing groove 27 are each rounded off. The first groove side wall 29 is located on the side of the groove bottom 28 farther away from the open axial end 9 of the bush 4 and has a much greater radial extension that the second groove side wall 30 which is located on the side of the groove bottom 28 closer to the open axial end 9 of the bush 4. The second groove side wall 30 is formed by a radial projection 31 which is located axially between the groove bottom 28 and the open axial end 9 of the bush 4. The radial projection 31 fixes the gasket 8 captively on the bush 4 when the journal 3 is not inserted into the bush 4. For this reason it is possible to manipulate the bush 4 and the gasket 8 as one unit.

The radial outer sealing lip 23 adjoins the groove bottom 28. That is, the radial outer sealing lip 23 contacts the axially extending and radially outwardly facing surface of the groove bottom 28. The axial outer sealing lip 24 adjoins the first groove side wall 29. That is, the axial outer sealing lip 24 contacts the radially extending and axially facing surface of the first groove side wall 29. In this way a high sealing action is achieved which is important when, for example, water or another liquid under high pressure is incident on the sealed region. The axial outer sealing lip 24 adjoining the first groove side wall 29 of the bush 4 can effectively prevent penetration of water into the interior of the bush 4. The selected geometry of the sealing body 13, especially the depression 26, results in the axial outer sealing lip 24 and also the radial outer sealing lip 23 being pressed by the water pressure even more strongly against the first groove side wall 29 and the groove bottom 28. In this way lifting of the outer sealing lips 23 and 24 by the incident water is prevented and a relatively high sealing action is achieved. Moreover, the axial outer sealing lip 24 is partially shielded against the incident water jet by the radially projecting first groove side wall 29 of the sealing groove 27. Without the action of water pressure, the outer sealing lips 23, 24 are pressed only with the intended pretensioning against the groove bottom 28 and the first groove side wall 29 and are subject to low friction and low wear. Only if an increased sealing action is necessary due to external effects is the contact pressure of the outer sealing lips 23, 24 increased by just these external effects. Especially for these effects which typically occur only occasionally can the friction and wear of the outer sealing lips 23, 24 be kept low in this way and while still permitting a reliable sealing to be guaranteed.

In the illustrated embodiment, the groove bottom 28 is made as a radially facing surface and the two groove side walls 29, 30 are each made as an axially facing surface. Only the groove bottom 28 and the first groove side wall 29 are necessary for sealing, and so the second groove side wall 30 can also be omitted and the sealing groove 27 thus can be modified to one step.

Other modifications are possible. For example, the radial outer sealing lip 23 need not necessarily adjoin the radially facing surface and the axial outer sealing lip 24 need not necessarily adjoin the axially facing surface. In any case, it is necessary for optimum sealing under the above named conditions that for the surface which the outer axial sealing lip 24 adjoins the axial portion of the surface normal is larger than for the surface which the outer radial sealing lip 23 adjoins. In other words, the surfaces should be made such that for the axial outer sealing lip 24 the axial sealing is more strongly pronounced than for the radially outer sealing lip 23, and for the radial outer sealing lip 23 the radial sealing is more strongly pronounced than for the axially outer sealing lip 24.

The two outer sealing lips 23, 24 can also adjoin surfaces which are made curved transversely to the respective outer sealing lip 23, 24. In this case, the considerations above are based on a center surface normal of the contact region.

The reliability of sealing is still further increased by the sealing body 13 having an axial projection 32 which axially adjoins/contacts the radially extending axial end face or surface of the bush 4 forming the open axial end 9. Moreover, the sealing body 13 has an inner sealing lip 33 which adjoins/contacts the inner periphery of the bush 4 and constitutes an additional barrier against penetrating substances or against escaping lubricant.

The antifriction bearing 2 can be mounted on the journal 3 as follows. The antifriction bearing 2 consisting of the bush 4, the stop disk 5, the roll bodies 6, the disk spring 7 and the gasket 8 is assembled and handled as a unit. This is enabled by the radial outer sealing lip 23 engaging the sealing groove 27 of the bush 4 and thus being attached captively to the bush 4. The roll bodies 6 are axially clamped by the disk spring 7 which is supported on the gasket 8 for this purpose. In any case, the clamping pressure of the disk spring 7 is very low so that the radial outer sealing lip 23 is not pressed out of the sealing groove 27 of the bush 4. Alternatively or additionally, the roll bodies 6 can also be fixed by grease which is used moreover as the lubricant.

The journal 3 is inserted into the open axial end 9 of the bush 4 for installation. In this connection, the gasket 8 via its axial projection 32 is supported on the bush 4. The seat surface 19 of the sealing body 13 axially slides over the journal 3 until it adjoins the opposing surface 20 of the journal 3. The correct position is reached when the sealing body 13 strikes the shoulder 21 of the journal 3. In this position, the disk spring 7 is compressed axially relative to the state before installation and adjoins the roll bodies 6 with axial pretensioning. The bush 4 can then be positioned in the desired installation environment and for example can be fixed by locking a snap ring into the retaining groove 12. Thus, during installation, the journal 3 is moved relative to the bush 4 so that as the gasket 8 approaches the defined seat position on the journal 3, the disk spring 7 is increasingly compressed by mechanical action of the gasket 8 on the disk spring 7, with a defined pretensioning being set by the compression of the disk spring 7.

The principles, preferred embodiment and other disclosed aspects of the antifriction bearing for pivoting support of an axle or journal have been described in the foregoing specification. However, the invention which is intended to be protected is not to be construed as limited to the particular embodiment and variations disclosed. Further, the embodiment described herein is to be regarded as illustrative rather than restrictive. Variations and changes may be made by others, and equivalents employed, without departing from the spirit of the present invention. Accordingly, it is expressly intended that all such variations, changes and equivalents which fall within the spirit and scope of the present invention as defined in the claims, be embraced thereby.

What is claimed is:

1. Bearing arrangement comprising:
a bush;
a journal pivotally supported in the bush;
roll bodies positioned between the bush and the journal which roll between the bush and the journal,
a gasket mounted on the journal;
a disk spring axially clamped with pretensioning between the gasket and the roll bodies;
wherein an axial distance between the disk spring and the roll bodies decreases in a radially outward direction at least in areas.

2. Bearing arrangement as claimed in claim 1, wherein the gasket comprises a sealing body possessing an inner periphery, and the sealing body possessing a seat surface at the inner periphery of the sealing body adjoining an opposing surface of the journal so that the seat surface radially overlaps the opposing surface of the journal to produce a torsionally strong connection of the gasket on the journal forming a seal.

3. Antifriction bearing for pivoting support of an axle or journal, comprising:
a bush;
roll bodies which roll in the bush;
a gasket;
a disk spring axially supported on the gasket, the disk spring contacting the roll bodies axially; and
wherein an axial distance between the disk spring and the roll bodies decreases in a radially outward direction at least in portions.

4. Antifriction bearing as claimed in claim 3, wherein the gasket comprises a sealing body and a support ring.

5. Antifriction bearing as claimed in claim 4, wherein the disk spring contacts the support ring.

6. Antifriction bearing as claimed in claim 4, wherein the support ring comprises an axially extending first tube section.

7. Antifriction bearing as claimed in claim 6, wherein the support ring further comprises a radially extending flange extending from one end of the axially extending first tube section.

8. Antifriction bearing as claimed in claim 7, wherein the radially extending flange is a radially outwardly extending flange located at least in one partial region of its radial extension outside the sealing body on an outer surface of the sealing body, the partial region being larger than half the radial extension of the flange.

9. Antifriction bearing as claimed in claim 7, wherein the radially extending flange is a radially inwardly extending flange.

10. Antifriction bearing as claimed in claim 9, wherein the disk spring contacts the radially inwardly extending flange.

11. Antifriction bearing as claimed in claim 6, wherein the support ring comprises an axially extending second tube section.

12. Antifriction bearing as claimed in claim 4, wherein the support ring is made of metal.

13. Antifriction bearing as claimed in claim 3, wherein the disk spring possesses a bent radial outer region that is bent relative to a radial inner region of the disk spring.

14. Antifriction bearing as claimed in claim 13, wherein the bent radial outer region encompasses a radially outwardmost portion of the disk spring.

15. Antifriction bearing as claimed in claim 13, wherein the roll bodies contact the bent radial outer region of the disk spring.

16. Antifriction bearing as claimed in claim 3, wherein the bush comprises a sealing groove, and the gasket comprises a sealing lip that is positioned in and engages the sealing groove so that the gasket is captively attached to the bush.

17. Antifriction bearing as claimed in claim 4, wherein the sealing body of the gasket possessing an inner periphery, and the sealing body possessing a seat surface at the inner periphery of the sealing body adapted to adjoin an opposing surface of the journal to produce a torsionally strong arrangement of the gasket on the journal.

18. Antifriction bearing as claimed in claim 4, wherein the sealing body of the gasket comprises at least one outer sealing lip which contacts an outer peripheral surface of the bush and at least one inner sealing lip which contacts an inner peripheral surface of the bush.

19. Antifriction bearing as claimed in claim 4, wherein the sealing body of the gasket comprises an axial projection which axially contacts a radially extending axial end surface of the bush.

20. Antifriction bearing as claimed in claim 4, wherein an outer peripheral surface of the bush is provided with a sealing groove, the support ring of the gasket comprising three bends so that the support ring comprises an axially extending inner tube section having opposite axial ends, a radially outwardly extending outer flange extending from one axial end of the inner tube section, a radially inwardly extending inner flange extending from the other axial end of the inner tube section, and an axially extending outer tube section extending from a radially outer end of the outer flange, and the sealing body of the gasket comprising a pair of spaced outer sealing lips and an inner sealing lip, one of the outer sealing lips contacting an outer peripheral surface of the bush and the inner sealing lip contacting an inner peripheral surface of the bush, at least one of the outer sealing lips being positioned in the sealing groove of the bush.

21. Swivel joint comprising a plurality of journals, and a plurality of antifriction bearings as claimed in claim 3, in which each journal is pivotally supported on one of the antifriction bearings.

22. Process for installing an antifriction bearing on a journal, the antifriction bearing comprising a bush, roll bodies, a gasket, and a disk spring held between the roll bodies and the gasket, the method comprising:
introducing the journal into the bush; and
moving the journal relative to the bush so that as the gasket approaches a defined seat position on the journal, the disk spring is increasingly compressed by mechanical action of the gasket on the disk spring.

23. Process as claimed in claim 22, wherein a defined pretensioning is set by the compression of the disk spring.
